(19) United States
(12) Patent Application Publication
(10) Pub. No.: US 2023/0212759 A1
(43) Pub. Date: Jul. 6, 2023

(54) SYSTEM AND METHOD FOR CO-PRODUCING ULTRA-HIGH PURITY OXYGEN AND ULTRA-HIGH PURITY HYDROGEN

(71) Applicants: Brian R. Kromer, Buffalo, NY (US); Daniel Palaniswamy Otte, Koenigsbrunn (DE)

(72) Inventors: Brian R. Kromer, Buffalo, NY (US); Daniel Palaniswamy Otte, Koenigsbrunn (DE)

(21) Appl. No.: 17/967,102

(22) Filed: Oct. 17, 2022

Related U.S. Application Data
(60) Provisional application No. 63/296,227, filed on Jan. 4, 2022.

(51) Int. Cl. C25B 1/04; C01B 3/50; C01B 13/02; C01B 21/04

(52) U.S. Cl. CPC C25B 1/04; C01B 3/508; C01B 13/0259; C01B 21/0433

(57) ABSTRACT

A system and method for co-producing ultra-high purity oxygen and ultra-high purity hydrogen from a water electrolysis unit is provided. The presently disclosed system and method includes upgrading the crude oxygen stream coming from the water electrolysis unit by means of a small, stand-alone cryogenic distillation system wherein the refrigeration for such cryogenic distillation system is supplied by a nitrogen recycle refrigeration loop.

### CROSS REFERENCE TO RELATED APPLICATIONS

This application claims the benefit of and priority to U.S. provisional patent application Ser. No. 63/296,227 filed Jan. 4, 2022, the disclosure of which is incorporated by reference.

### TECHNICAL FIELD

The present invention relates to a system and method for co-producing ultra-high purity oxygen and ultra-high purity hydrogen, and more particularly to a system and method of purifying or upgrading a crude oxygen stream and crude hydrogen stream produced from an electrolysis unit.

### BACKGROUND

The electronics manufacturing industry, including semiconductor fabs often requires ultra-pure gases, including ultra-high purity oxygen and ultra-high purity hydrogen. Ultra-high purity oxygen, typically defined as having less than 10 ppb of argon and less than 10 ppb of nitrogen as well as less than 80 ppb of other impurities such as hydrogen, water, carbon dioxide, and hydrocarbons, is used for growing oxide layers in etching operations. Ultra-high purity hydrogen gas will have less than about 3.5 ppm nitrogen and less than 1 ppm of each of the other common impurities including water, carbon dioxide, carbon monoxide, oxygen, argon, and hydrocarbons. Ultra-high purity hydrogen is typically used for example during epitaxial deposition of silicon and silicon germanium and for surface preparation. As semiconductor fabs increase in size and operate with higher process intensities, the demand for ultra-high purity hydrogen is rapidly increasing and the production of hydrogen through environmentally sustainable on-site electrolysis systems is also expected to grow.

Co-production of ultra-high purity electronics grade oxygen and hydrogen from a water electrolysis system is expensive, and for that reason, the supply of ultra-high purity oxygen is taken from a different source. The crude oxygen leaving a typical water electrolysis unit will likely have impurity levels exceeding the requirements for electronics industry fabrication processes. The crude oxygen stream typically will include about 1.5% hydrogen, as well as about >1 ppm argon and >1 ppm nitrogen and will be saturated with water. The crude oxygen stream will go through conventional catalytic and drying processes which will remove the water as well as reduce the hydrogen concentration to less than about 1 ppm. To further purify the resulting oxygen stream and further reduce the hydrogen, argon and nitrogen impurities often requires integration with large air separation units and possible compression of the crude oxygen stream in order to produce the ultra-high purity oxygen product. Likewise, the crude hydrogen stream exiting the electrolysis unit will go through a conventional deoxo catalytic process to reduce the oxygen impurities and subsequent drying processes to remove the water to levels required by the electronics industry customers.

What is needed is a lower cost, stand-alone, purification system and method to co-produce ultra-high purity oxygen product and an ultra-high purity hydrogen product from a crude oxygen and crude hydrogen streams produced by an electrolysis system that does not require integration into the coldbox of a full air separation unit and does not require oxygen compression.

### SUMMARY OF THE INVENTION

The present invention may be characterized as a system for co-producing an ultra-high purity oxygen product stream and an ultra-high purity hydrogen product stream from a stream of feed water comprising: (i) a water pre-purification subsystem configured to receive the stream of feed water and produce a purified, de-ionized water stream; (ii) one or more electrolysis units configured to receive the purified, de-ionized water stream and produce one or more crude oxygen streams and one or more crude hydrogen streams; (iii) an oxygen purification subsystem configured for receiving the one or more crude oxygen streams and produce the ultra-high purity oxygen product stream; and (iv) a hydrogen purification subsystem configured to receive the one or more crude hydrogen streams and produce the ultra-high purity hydrogen stream.

The hydrogen purification subsystem preferably comprising a deoxo catalyst for removing oxygen impurities from the one or more crude hydrogen streams to produce a hydrogen-rich effluent stream substantially free of oxygen and a dryer configured for drying the hydrogen-rich effluent stream to produce the ultra-high purity hydrogen product stream.

Likewise, the oxygen purification subsystem preferably comprises a catalyst or adsorbent subsystem configured for removing hydrogen from the one or more crude oxygen streams to produce an oxygen-rich effluent stream, a dryer configured for drying the oxygen-rich effluent stream to produce a dried oxygen-rich effluent stream, and a distillation column subsystem configured to receive the dried oxygen-rich effluent stream and to separate argon and other impurities from the dried oxygen-rich effluent stream to produce an ultra-high purity oxygen product stream.

The distillation column subsystem includes a distillation column and a main heat exchanger. The distillation column is designed or configured to separate argon, nitrogen, and hydrogen from the dried oxygen-rich effluent stream by rectifying an ascending vapor stream and a descending liquid stream of reflux to produce an ultra-high purity oxygen bottoms, an impurity containing overhead stream extracted from a location near the top of the distillation column. The dried oxygen-rich effluent stream is preferably introduced into the distillation column at an intermediate location.

The main heat exchanger is configured to cool the dried oxygen-rich effluent stream to a liquid oxygen stream before introduction to the distillation column and also cool the nitrogen recycle stream via indirect heat exchange with another portion of ultra-high purity oxygen bottoms and a nitrogen boil-off stream from a condenser.

The distillation column subsystem preferably also includes the aforementioned condenser disposed proximate the top section of the distillation column and a reboiler disposed proximate the bottom section of the distillation column. The condenser is preferably configured for condensing a portion of the impurity containing overhead stream from the distillation column against a liquid nitrogen stream to produce a liquid reflux stream and a nitrogen boil-off stream. The nitrogen boil-off stream is then recycled back to the main heat exchanger as a cooling stream while a portion of the overhead stream and a portion of the liquid reflux stream may be vented as a waste stream to remove the impurities from the distillation column subsystem. The reboiler is configured for reboiling a portion of ultra-high purity oxygen bottoms against the nitrogen stream to produce the ascending vapor in the distillation column and a liquid nitrogen stream directed to the condenser disposed at the top of the distillation column. The distillation column subsystem also preferably includes a nitrogen recycle compressor configured for compressing the nitrogen recycle stream traversing the main heat exchanger, the condenser and the reboiler.

In some embodiments, the dryer in the oxygen purification subsystem further comprises a separator and dryer configured to remove water and water vapor from the oxygen-rich effluent stream. In other embodiments, the oxygen purification subsystem may include or comprise a temperature swing adsorption purification unit configured to remove water vapor, carbon dioxide and/or other impurities, including hydrogen, from the oxygen-rich effluent stream.

The present invention may also be characterized as a method for co-producing an ultra-high purity oxygen product and an ultra-high purity hydrogen product from a stream of feed water comprising the steps of (a) purifying a stream of feed water to produce a purified, de-ionized water stream; (b) directing the purified, de-ionized water stream to one or more electrolysis units configured to produce one or more crude oxygen streams and one or more crude hydrogen streams; (c) removing hydrogen from the one or more crude oxygen streams in a catalyst or adsorbent subsystem to produce an oxygen-rich effluent stream; (d) drying the oxygen-rich effluent stream to remove water vapor and produce a dried oxygen-rich effluent stream; (e) separating argon and other impurities the dried, oxygen-rich effluent stream in a distillation column subsystem, described above that is configured to receive the dried oxygen-rich effluent stream and one or more nitrogen streams to produce the ultra-high purity oxygen product; (f) removing oxygen impurities from the one or more crude hydrogen streams using a deoxo catalyst to produce a hydrogen-rich effluent stream substantially free of oxygen; and (g) drying the hydrogen-rich effluent stream to produce the ultra-high purity hydrogen product.

### BRIEF DESCRIPTION OF THE DRAWINGS

It is believed that the claimed invention will be better understood when taken in connection with the accompanying drawings in which:

FIG. 1 shows a schematic of the present system and method for co-producing an ultra-high purity oxygen product stream and an ultra-high purity hydrogen product stream from an electrolysis system; and

FIG. 2 shows a detailed schematic of the process flow diagram of an embodiment of the cryogenic distillation subsystem suitable for use with the present system and method of FIG. 1.

### DETAILED DESCRIPTION

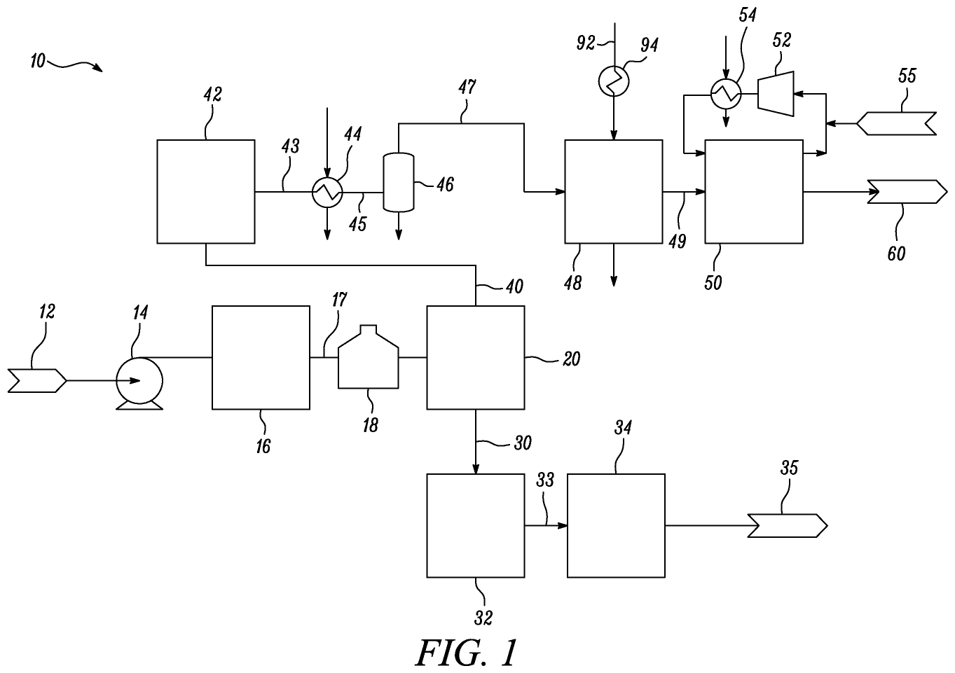

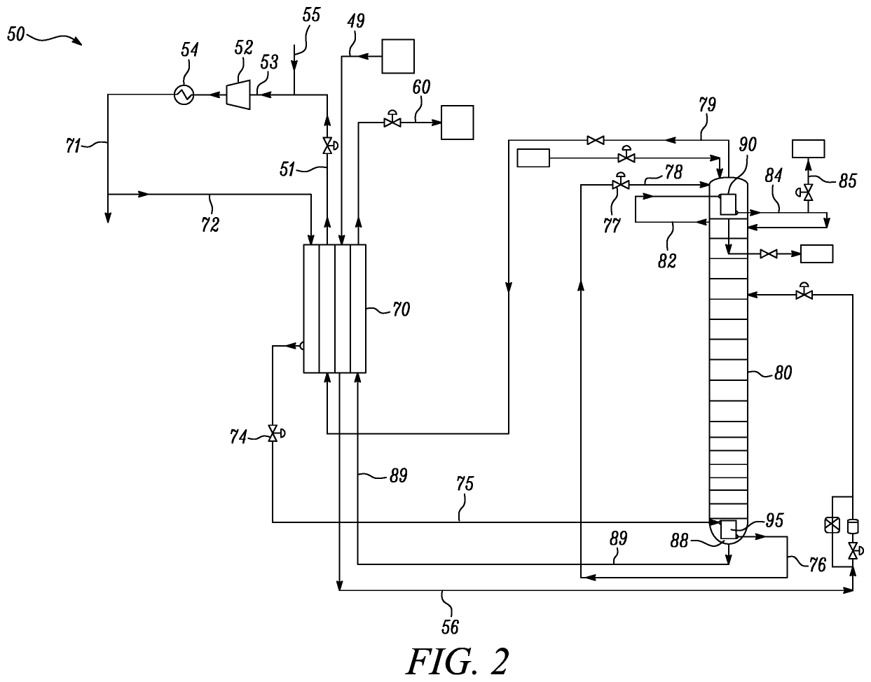

The present system and method 10 for co-producing ultra-high purity oxygen and ultra-high purity hydrogen from a water electrolysis unit is schematically depicted in FIG. 1 and FIG. 2. A differentiating aspect of the present system and method is the upgrading of the crude oxygen stream coming from the water electrolysis unit by means of a small, stand-alone cryogenic distillation system and process where the refrigeration for such cryogenic distillation system and process is driven with a nitrogen recycle loop.

As seen in FIG. 1, feed water 12 is preferably pumped via water pump 14 to a water purification subsystem 16 where it is purified and de-ionized. The purified and de-ionized water 17 is directed to a water tank 18 that is arranged to feed the electrolysis unit 20. The electrolysis unit 20 can be a polymer electrolyte membrane (PEM) electrolysis unit but is preferably an alkaline electrolysis unit, as the alkaline electrolysis unit typically has lower capital costs than PEM electrolysis units and is capable of producing the crude oxygen stream at a higher outlet pressure. The electrolysis unit 20 separates the purified water into a crude hydrogen stream 30 and a crude oxygen stream 40.

The ultra-high purity hydrogen stream 35 is produced by subjecting the crude hydrogen stream 30 exiting the electrolysis unit 20 to a deoxo catalyst 32 configured for removing oxygen impurities from the crude hydrogen stream 30 to produce a hydrogen-rich effluent stream 33 substantially free of oxygen and a dryer 34 configured for drying the hydrogen-rich effluent stream substantially free of oxygen 33 to produce the ultra-high purity hydrogen product stream 35. The resulting ultra-high purity hydrogen stream 35 preferably has less than about 3.5 ppm nitrogen and less than about 1 ppm of each of the other common impurities including water, carbon dioxide, carbon monoxide, oxygen, argon, and other hydrocarbon impurities.

The ultra-high purity oxygen stream 60 is produced by subjecting the crude oxygen stream 40 exiting the electrolysis unit 20 to an optional electric heater (not shown) and then to catalyst system 42 configured for removing hydrogen impurities from the crude oxygen stream 40 to produce an oxygen-rich effluent stream 43 substantially free of hydrogen is then cooled in aftercooler 44 via indirect heat exchange with a cooling water circuit. Water is then removed from the cooled, oxygen-rich effluent stream 45 in a separator 46. The oxygen-rich vapor effluent 47 from the separator 46 is directed to a dryer 48 configured for drying the oxygen-rich vapor effluent stream 47 preferably using a heated nitrogen regen stream 92 that is heated in a regen heater 94. In some embodiments, the dryer could be configured as an adsorption system, such as a temperature swing adsorption system, configured to remove water vapor and carbon dioxide from the oxygen-rich effluent stream.

The dried, oxygen-rich vapor effluent stream 49 that may include approximately 1 ppm of argon, 1 ppm of hydrogen, and 2 ppm of nitrogen is then directed to a cryogenic distillation system 50 and the refrigeration for such cryogenic distillation is driven with a nitrogen recycle loop that includes a nitrogen recycle compressor 52 and aftercooler 54. A source of pressurized gaseous nitrogen 55 is used for the refrigeration circuits in the cryogenic distillation system 50. The resulting ultra-high purity oxygen stream 60 contains less than about 10 ppb argon, and more preferably less than about 5 ppb of argon. In addition, the ultra-high purity oxygen stream 60 exiting the cryogenic distillation system 50 has less than 10 ppb, and more preferably less than about 1 ppb, of nitrogen as well as less than 10 ppb, and more preferably less than about 1 ppb, of hydrogen.

As indicated above, the cryogenic distillation process used in purifying the crude oxygen stream 40 may be implemented using a relatively small, stand-alone cryogenic distillation system 50 without the need to integrate the cryogenic distillation system and process within a cold-box of a large air separation unit. The small, stand-alone cryogenic distillation system 50 and process is self-contained and generates its own refrigeration by means of a nitrogen recycle loop and produces the ultra-high purity oxygen stream 60 without the need for oxygen compression. Although turboexpanders may be used to generate the refrigeration needed by the small, stand-alone system, a lower-cost alternative using Joule-Thomson expansion valves to generate the required refrigeration is preferred.

Turning now to FIG. 2, a schematic process flow diagram of the small, stand-alone cryogenic distillation system 50 is shown. The dried, oxygen-rich vapor effluent 49 is fed through a main heat exchanger 70 where it is fully condensed against boiling ultra-high purity product oxygen 89. The resulting liquid oxygen stream 56 exiting the cold end of the main heat exchanger 70 is introduced into an intermediate location of the distillation column 80, approximately 20% of the column height below from the top of the distillation column 80. The rising vapor in the distillation column 80 carries the more volatile impurities such as argon, nitrogen, and hydrogen to the top of the distillation column 80. A fraction of the vapor may be vented to release impurities while the remaining overhead vapor 82 is condensed in condenser 90 and sent back to the distillation column 80 as liquid reflux 84 where it forms the descending liquid. Non-condensable impurities may also be vented as a vent stream 85 from the condensed reflux stream 84. The descending liquid becomes higher in oxygen purity as it descends the distillation column 80, and a portion of ultra-high purity liquid oxygen stream 89 is withdrawn at the bottom of the distillation column 80. The remaining ultra-high purity liquid oxygen 88 is reboiled in reboiler 95 against a nitrogen stream and sent up the distillation column as the ascending vapor.

The distillation column 80 consists of between 40 and 130 stages of separation, and more preferably between 80 and 130 stages of separation, for example about 90 stages of separation. The number of stages of separation in the distillation column 80 depends on the level of argon in the dried, oxygen-rich vapor effluent 49. For example, if one degasses the feed water using an aeration unit as part of the water purification system to reduce the argon level in the water, a smaller distillation column could be used to achieve the purity levels required for the ultra-high purity oxygen product. The ultra-high purity liquid oxygen stream 89 withdrawn at the bottom of distillation column 80 is boiled and warmed in the main heat exchanger 70 and supplied to the customer as an ultra-high purity oxygen product 60. The ultra-high purity oxygen product 60 is preferably produced at pressures between about 9 bar(a) and 11 bar(a) and the distillation column 80 also operates at similar pressures.

The refrigeration and driving force for the reboiler 95 and condenser 90 comes from a nitrogen recycle loop. The nitrogen recycle loop eliminates the need for oxygen compression which can add significant capital and operational cost to the present system 10 and also introduce complexity into the present system required to address safety considerations regarding oxygen compression. The recycle aspect of the nitrogen recycle loop minimizes the amount of nitrogen that has to be introduced into the process from an external source. As seen in FIG. 2, a pressurized gaseous nitrogen stream 72 at about 35 bar(a) enters the main heat exchanger 70 where it is cooled via indirect heat exchange against a returning nitrogen stream 79, the ultra-high purity liquid oxygen stream 89, and the dried, oxygen-rich vapor effluent stream 49. The cooled nitrogen stream 75 exits the main heat exchange 70 at an intermediate location before the cold end of the main heat exchanger 70. Nitrogen is supplied to the oxygen purification subsystem from an external source and is used for the regen flow 92 to the dryer as well as for the refrigeration circuit in the distillation column system 50.

Refrigeration for the process is generated by expanding the gas in a valve to a lower pressure of about 27 bar(a) using a Joule-Thomson expansion valve 74. The cooled, expanded nitrogen gas stream 75 is then fed into the reboiler 95 at the bottom of the distillation column 80 where is condensed against the boiling oxygen 88. The liquid nitrogen stream 76 exiting the reboiler 95 is then throttled via valve 77 to lower pressure of about 22 bar(a) in order to decrease its boiling point. This throttle nitrogen stream 78 is then fed into condenser 90 disposed at the top of the distillation column 80 where the throttle nitrogen stream 78 is boiled against the condensing oxygen stream 82. The gaseous nitrogen stream 79 leaving the condenser 90 is then warmed in the main heat exchanger 70 to near ambient temperature. The warmed nitrogen stream 51 is then combined with a small make up stream of pressurized gaseous nitrogen 55. The combined recycle stream 53 is then compressed in the recycle compressor 52 and cooled in aftercooler 54 to produce a cooled, compressed nitrogen stream 71. A portion of the compressed, cooled recycle stream is them recycled to the main heat exchanger 70 as the pressurized gaseous nitrogen stream 72.

While the present system and method for co-producing an ultra-high purity oxygen product and an ultra-high purity hydrogen product have been described with reference to a preferred embodiment, it is understood that numerous additions, changes, and omissions can be made without departing from the spirit and scope of the present inventions as set forth in the appended claims.

For example, one can design and operate a system that employs one or more electrolysis units each producing a crude oxygen stream and a crude hydrogen stream and wherein the oxygen purification subsystem, including the cryogenic distillation column system, is configured to process the one or more crude oxygen streams collectively. Similarly, the hydrogen purification subsystem may be configured to process the one or more crude hydrogen streams collectively or separately.

What is claimed is:

1. A system for co-producing an ultra-high purity oxygen product stream and an ultra-high purity hydrogen product stream from a stream of feed water comprising:
a water pre-purification subsystem configured to receive the stream of feed water and produce a purified, de-ionized water stream;
one or more electrolysis units configured to receive the purified, de-ionized water stream and produce one or more crude oxygen streams and one or more crude hydrogen streams;
an oxygen purification subsystem comprising a distillation column arrangement configured to separate argon and other impurities from the one or more crude oxygen streams and produce the ultra-high purity oxygen product stream; and
a hydrogen purification subsystem configured to receive the one or more crude hydrogen streams and produce the ultra-high purity hydrogen product, the hydrogen purification subsystem comprising a deoxo catalyst for removing oxygen impurities from the one or more crude hydrogen streams to produce a hydrogen-rich effluent stream substantially free of oxygen and a hydrogen dryer configured for drying the hydrogen-rich effluent stream to produce the ultra-high purity hydrogen product.

2. The system for co-producing the ultra-high purity oxygen product stream and the ultra-high purity hydrogen product stream of claim 1, wherein the oxygen purification subsystem further comprises an oxygen dryer configured to remove water vapor from the one or more crude oxygen streams.

3. The system for co-producing the ultra-high purity oxygen product stream and the ultra-high purity hydrogen product stream of claim 2, wherein the oxygen dryer further comprises a temperature swing adsorption system configured to remove water vapor from the oxygen-rich effluent stream.

4. The system for co-producing the ultra-high purity oxygen product stream and the ultra-high purity hydrogen product stream of claim 3, wherein the temperature swing adsorption system further comprises one or more adsorbents or catalysts configured to remove carbon dioxide and/or other impurities from the oxygen-rich effluent stream.

5. The system for co-producing the ultra-high purity oxygen product stream and the ultra-high purity hydrogen product stream of claim 1 wherein the oxygen purification subsystem further comprises a catalyst or adsorbent subsystem configured for removing hydrogen from the one or more crude oxygen streams to produce an oxygen-rich effluent stream; and an oxygen dryer configured for drying the oxygen-rich effluent stream to produce a dried oxygen-rich effluent stream.

6. The system for co-producing the ultra-high purity oxygen product stream and the ultra-high purity hydrogen product stream of claim 1 wherein the distillation column arrangement further comprises:
a distillation column configured to separate argon and other impurities of the dried oxygen-rich effluent stream by rectifying an ascending vapor stream and a descending liquid reflux stream to produce an ultra-high purity oxygen bottoms and an argon containing overhead stream extracted from the distillation column proximate a top section of the distillation column;
a condenser disposed proximate the top section of the distillation column and configured for condensing a portion of the argon containing overhead stream against a liquid nitrogen stream to produce a nitrogen boil-off stream and the liquid reflux stream;
a reboiler disposed proximate the bottom section of the distillation column and configured for reboiling a first portion of ultra-high purity oxygen bottoms against a cooled, expanded nitrogen recycle stream to produce the ascending vapor stream and the liquid nitrogen stream; and
a main heat exchanger configured to cool the dried oxygen-rich effluent stream and cool a nitrogen recycle stream via indirect heat exchange with a second portion of ultra-high purity oxygen bottoms and the nitrogen boil-off stream from the condenser.

7. The system for co-producing the ultra-high purity oxygen product stream and the ultra-high purity hydrogen product stream of claim 6 wherein the distillation column subsystem further comprises:
a recycle compressor configured for compressing the warmed boil-off stream to produce the compressed nitrogen recycle stream;
the main heat exchanger configured to cool the compressed nitrogen recycle stream; and
an expansion valve configured for expanding the cooled, compressed nitrogen recycle stream to produce the cooled, expanded nitrogen recycle stream.

8. The system for co-producing the ultra-high purity oxygen product stream and the ultra-high purity hydrogen product stream of claim 7 further comprising one or more turbines operatively coupled to a booster, a generator, an oil brake, or an air brake, the one or more turbines configured to produce refrigeration for liquid oxygen production.

9. The system for co-producing the ultra-high purity oxygen product stream and the ultra-high purity hydrogen product stream of claim 1 wherein the one or more crude oxygen streams further comprises a crude oxygen stream from a storage tank or a truck in addition to the one or more crude oxygen streams from the one or more electrolysis units.

10. The system for co-producing the ultra-high purity oxygen product stream and the ultra-high purity hydrogen product stream of claim 1 wherein the catalyst or adsorbent subsystem configured for removing hydrogen from the one or more crude oxygen streams to produce an oxygen-rich effluent stream further comprises a heater configured for heating the one or more crude oxygen streams, a catalytic oxidizer bed configured for receiving the heated crude oxygen streams and removing hydrogen and other volatile organic compounds therefrom to produce the oxygen-rich effluent stream.

11. The system for co-producing the ultra-high purity oxygen product stream and the ultra-high purity hydrogen product stream of claim 1 wherein the oxygen purification subsystem further comprises a separator and dryer configured to remove water and water vapor from the oxygen-rich effluent stream.

12. The system for co-producing the ultra-high purity oxygen product stream and the ultra-high purity hydrogen product stream of claim 1 wherein the water purification subsystem further comprises an aeration unit configured to remove dissolved gases from the de-ionized water stream to produce the purified, de-ionized water stream.

13. A method for co-producing an ultra-high purity oxygen product stream and an ultra-high purity hydrogen product stream from a stream of feed water comprising:
purifying the stream of feed water to produce a purified, de-ionized water stream;
directing the purified, de-ionized water stream to one or more electrolysis units configured to produce one or more crude oxygen streams and one or more crude hydrogen streams;
separating argon and other impurities from the one or more crude oxygen streams in a distillation column arrangement configured to produce the ultra-high purity oxygen stream;
removing oxygen impurities from the one or more crude hydrogen streams using a catalyst to produce a hydrogen-rich effluent stream substantially free of oxygen; and
drying the hydrogen-rich effluent stream to produce the ultra-high purity hydrogen product stream.

14. The method of claim 13, further comprising the steps of:
removing hydrogen from the one or more crude oxygen streams to produce an oxygen-rich effluent stream; and
drying the oxygen-rich effluent stream to remove water vapor and produce a dried oxygen-rich effluent stream;
wherein the distillation column arrangement is configured to receive the dried, oxygen-rich effluent stream and produce the ultra-high purity oxygen stream.

15. The method of claim 13, wherein the step of separating argon and other impurities from the dried, oxygen-rich effluent stream in a distillation column subsystem further comprises:
rectifying the dried, oxygen-rich effluent stream against a descending liquid stream of reflux to produce an ultra-high purity oxygen bottoms and an argon containing overhead stream extracted from the distillation column proximate a top section of the distillation column;
condensing argon containing overhead stream against a stream of liquid nitrogen to produce a nitrogen boil-off stream and the argon containing waste stream in a condenser disposed proximate the top section of the distillation column;
reboiling a first portion of ultra-high purity oxygen bottoms against a nitrogen recycle stream in a reboiler disposed proximate the bottom section of the distillation column;
cooling the dried, oxygen-rich effluent stream in a main heat exchanger via indirect heat exchange with a second portion of ultra-high purity oxygen bottoms; and
cooling the nitrogen recycle stream in the main heat exchanger via indirect heat exchange with the nitrogen boil-off stream from the condenser.

16. The method of claim 15, further comprising the step of compressing the warmed nitrogen boil-off stream exiting the main heat exchanger using a recycle compressor to form the compressed nitrogen recycle stream.

17. The method of claim 13, further comprising the step of heating the one or more crude oxygen streams before the step of removing hydrogen in a catalyst or adsorbent subsystem to produce an oxygen-rich effluent stream.

18. The method of claim 13, wherein the step of drying the oxygen-rich effluent stream to produce a dried, oxygen rich effluent stream further comprises separating the oxygen-rich effluent stream to remove a condensate and then drying the resulting vapor stream to remove water vapor the oxygen-rich effluent stream.

19. The method of claim 13, wherein the step of purifying the stream of feed water further comprises degassing the de-ionized water stream in an aeration unit configured to remove dissolved gases from the de-ionized water stream to produce the purified, de-ionized water stream.
